(19) United States
(12) Patent Application Publication
(10) Pub. No.: US 2015/0332129 A1
(43) Pub. Date: Nov. 19, 2015

(54) Imaging Apparatus

(71) Applicant: Richard B. Murphy, San Diego, CA (US)

(72) Inventor: Richard B. Murphy, San Diego, CA (US)

(21) Appl. No.: 14/712,890

(22) Filed: May 14, 2015

Related U.S. Application Data
(60) Provisional application No. 61/996,672, filed on May 14, 2014.

(51) Int. Cl. G06K 9/82; H04N 1/00; G06K 9/22; G06T 1/00; G06F 17/30; G06K 9/20

(52) U.S. Cl. CPC G06K 9/82; G06F 17/30011; G06F 17/30253; G06K 9/2027; G06K 9/22; G06T 1/0007; H04N 1/00307; G06K 2209/01; G06T 2207/10004; G06T 2207/10152; G06T 2207/30176; H04N 2201/0422; H04N 2201/0436; H04N 2101/00

(57) ABSTRACT

The present invention provides a system to facilitate the imaging of objects using a portable computing device equipped with an imaging system invention providing a means to stably position a portable computing device in an elevated position above a surface to enable the rear facing camera of said device to image objects positioned thereunder. The invention further provides illumination systems and lenses to facilitate imaging.

### CROSS REFERENCE TO OTHER APPLICATIONS

The present application claims the benefit under 35 USC 119(e) of U.S. Provisional Patent Application Ser. No. 61/996,672 filed May 14, 2014, the entire teaching of which is herein incorporated by reference.

### BACKGROUND OF THE INVENTION

It is a common need in business to be able to create digital versions of physical documents such as business correspondence, articles, and photographs. Digital versions of tangible documents have myriad advantages such as compact storage, ease of transport, ability to convert to digital form via optical character recognition technologies, and ease of communication. The proliferation of multifunction printer/scanners facilitate the digital imaging of such materials recognize and address this need to some extent. Additionally, there are commercially available camera-based systems that are specially designed for use in imaging documents such as those provided by the ELMO Corporation. However, these devices are conventionally large and expensive devices primarily designed for use in a fixed location.

The use of cellular telephones and other portable computing devices has become ubiquitous. Many cellular telephones and tablet devices are fitted with high quality imaging systems capable of digital still or digital motion picture photography. Furthermore, many of such tablet and telephone devices further provide an integral illumination source sufficient to facilitate still or motion picture photography. Such devices often further provide a screen enabling the user to visualize the subject of the photograph prior to capture by the imaging system as well as facilitating the visualization of images stored on the device or over computer networks. Many of these devices also provide a means for storing images, generally on solid state media, as well as communicating images via wireless communication systems.

The present invention provides a compact portable system to facilitate imaging of objects using a portable computing device equipped with an imaging system.

### SUMMARY OF THE INVENTION

The present invention provides an apparatus to facilitate the imaging of objects using a portable imaging device such as a smartphone comprising an imaging system.

### BRIEF DESCRIPTION OF THE FIGURES

FIG. 1 of the attached drawings provides an upper perspective view of one embodiment of the platform of the present invention illustrating upper surface of the platform, a recess for receiving a PID and aperture.

FIG. 2 of the attached drawings provides a lower perspective view of one embodiment of the platform of the present invention illustrating the lower surface of the platform, supports (here illustrated in a retracted position into recesses provided in the under surface of the platform), an illumination system comprising LED strip lights and a series of batteries provided in a recess in the lower surface of the platform.

FIG. 3 of the attached drawings provides an upper perspective view of one embodiment of the platform of the present invention illustrating upper surface of the platform, a recess for receiving a PID and aperture and four support members shown in their extended position.

FIG. 4 of the attached drawings provides an upper perspective exploded view of one embodiment of the apparatus of the present invention illustrating the upper surface of the platform designed to receive a PID adapter (dotted lines), a PID adapter providing a recess for receiving a PID, aperture and four supports shown in an extended position.

FIG. 5 of the attached drawings provides an upper perspective assembled view of one embodiment of the platform of the present invention illustrating the PID adapter in association with upper surface of the platform, the PID adapter providing a recess for receiving a PID, and aperture.

FIG. 6, Panel A, of the attached drawings provides an upper perspective view of one embodiment of the invention illustrating the platform, two two-piece supports. each two-piece support comprising an upper member a lower member capable of independent pivotal rotation as illustrated by the curved arrows, and a pivot shaft. FIG. 6, Panel B provides a detailed view of the point of rotation between the upper and lower members of the two-piece support. Although not illustrated, the upper portion of each two piece support is hingedly attached to the under surface of the platform enabling the two-piece support to fold up into a recess provided in the lower surface of the platform.

FIG. 7 provides an upper perspective view of one embodiment of the invention where the platform is supported by a single support and base structure. Although illustrated here in its extended position, the upper surface of the base provides a recess to receive the support and platform structure when not in use, the support being telescopic and hingedly attached to the platform at its upper and hingedly attached to the base at its lower end. Also illustrated in FIG. 7 are the recess in the platform to receive the PID and aperture.

FIG. 8 provides an upper perspective view of one embodiment of the invention where the platform is supported by a single support and base structure illustrated here in its retracted position, the support and platform being received by a recess in the upper surface of the base to receive the support an platform, the support being telescopic and hingedly attached to the platform at its upper extent and hingedly attached to the base at its lower extent. Also illustrated in FIG. 7 are the recess in the platform to receive the PID and aperture.

FIG. 9 provides an upper perspective detailed view of the platform support interface when a single support is employed. Illustrated in FIG. 9 is the support, platform, PID recess, aperture and hinge mechanism.

FIG. 10 an upper perspective view of one embodiment of the invention where the platform is supported by a single articulated two-piece support and base structure illustrated here in its extended position, the support and platform being received by a recess in the upper surface of the base, the support being hingedly attached to the platform at its upper extent and hingedly attached to the base at its lower extent. Also illustrated in FIG. 10 are the recess in the platform to receive the PID and aperture.

### DETAILED DESCRIPTION OF THE INVENTION

Detailed embodiments of the present invention are disclosed herein. However, it is to be understood that the disclosed embodiments are merely illustrative of the invention that may be embodied in various forms. In addition, each of the examples given in connection with the various embodiments of the invention are intended to be illustrative, and not restrictive. Further, the figures are not necessarily to scale, some features may be exaggerated to show details of particular components. Therefore, specific structural and functional details disclosed herein are not to be interpreted as limiting, but merely as a representative basis for teaching one skilled in the art to variously employ the present invention. Furthermore, any section headings are merely for convenience of the reader and not intended to provide a limitation on the scope of the disclosure with respect to any feature of utility of the present invention.

Camera:

As used herein the term “camera” refers to the rear-facing camera of a PID. The term “rear-facing” refers to the situation where the camera aperture and the display of the PID are on the opposite sides of the PID. Such cameras typically comprise a digital image sensor capable of acquiring and digitizing images and one or more lenses to focus the image on the image sensor. Examples of digital image sensors include but are not limited to the charge coupled device (CCD) or the complementary metal-oxide-semiconductor (CMOS) active pixel sensor imagers.

The present invention provides an apparatus to facilitate imaging of objects by a portable imaging device (PID), said apparatus comprising:
(a) a platform, said platform having an upper and lower surface, said platform further providing a recess on its upper surface to reversible receive at least a portion of a PID, said PID having an image capture system comprising a rear-facing camera,
(b) said platform further providing an aperture extending from the face of said recess to through the lower surface of said platform, said aperture enabling the passage of light through the body of the platform to the rear facing camera of a PID, and
(c) one or more supports, said supports being operably associated with said platform to facilitate stable elevation of the platform above a surface.

The invention further an apparatus to facilitate imaging of objects by a portable imaging device (PID), said apparatus comprising:
(a) a platform, said platform having an upper and lower surface, said platform further providing a recess on its upper surface to reversibly receive at least a portion of a PID adapter,
(b) A PID adapter having an upper and lower surface the upper surface of said PID adapter providing a recess to receive at least a portion of a PID, said PID having an image capture system comprising a rear-facing camera,
(c) said PID adapter further providing an aperture extending from the face of said recess to through the lower surface of said PID adapter, said aperture enabling the passage of light through the body of the PID adapter to the rear facing camera of a PID, and
(d) one or more supports, said supports being operably associated with said platform to facilitate stable elevation of the platform above a surface.

The apparatus of the present invention may be used for the imaging of objects placed under the platform by a PID. In particular, the present invention may be used in the imaging of “documents.” As used herein, the term “document” is not limited to its conventional sense as a paper object but rather is defined herein to refer to a substantially two-dimensional object containing text, images or both text and images. The term document includes letters, notes, receipts, magazines, books, newspapers, photographs, newspapers, x-ray films, or and the like. The term document also includes physical, substantially two-dimensional objects to be imaged such as two-dimensional objects including but not limited to electrophoresis gels (e.g. 2D polyacrylamide gels), lateral flow immunoassay devices, ELISA, thin layer chromatographs, and agarose sequencing gels. The scope of objects that may be imaged according to the present invention includes a portion of the human body such as a portion of the skin.

### Portable Imaging Device:

The term portable imaging device (PID) as used herein is used to describe a portable electronic device comprising an integrated image capture system (e.g. a camera), means for storing digital information (e.g. integrated or removable solid state memory) and display system such that the device is capable of capturing, storing and preferably, displaying the image to be acquired by the image sensor and stored in the PID's memory. Commercially available examples of such PID devices include smartphones, tablets, and hybrid (commonly referred to as “phablet”) devices including but not limited to the iPhone® 1, 2, 3, 4, 4S, 5, 5S, 5C, 6 and 6 Plus, the iPad® 1^{st} Generation, iPad 2^{nd} Generation, iPad® 3^{rd} Generation, iPad Mini® 1^{st} Generation, iPod Touch® 1^{st} iPod Touch® Generation 2^{nd} Generation, iPod Touch® 3^{rd} Generation all commercially available from Apple Computer Corporation, Nokia® Lumia® series tablet devices such as models 635, 640, 830, 920, 1020, and 1520, Surface series tablets including the Surface 3, Surface 3 Pro Lenovo® IdeaPad® series tablets, Nexus® tablet devices, and Amazon® Kindle® series devices.

The image capture system of the PID is generally comprised of an image sensor and one or more lenses. The term “image sensor” as used herein to refer to a means to acquire an optical image and convert said optical image into an electronic signal. An image sensor may be used to digitize individual still images or for digitization of multiple images in the form of motion picture images. Examples of digital image sensors include but are not limited to the charge coupled device (CCD) or the complementary metal-oxide-semiconductor (CMOS) active pixel sensor imagers. The image capture system may also incorporate elements to provide for focusing, auto-focusing and/or “zoom” functions.

The term “means for storing digital information” refers to conventional computer readable memory for the storage of digital information such as solid state memory systems, SD cards, USB memory cards, hard drives, and the like.

The term “means to display the image” refers to a means to provide a two-dimensional preview representation of the image to be acquired by the image capture system and for the display of stored images. Commercially available versions of such displays include but are not liquid crystal displays as well as light emitting diodes (LED), polymer light emitting diodes (PLED), organic light emitting diodes (OLED), polymer organic light emitting diodes (POLED), passive matrix organic light emitting diode (PMOLED), or active matrix organic light emitting diode (AMOLED) arrays. Such displays may also incorporate touch screen technology to facilitate manipulation (e.g. zoom, rotation, or perspective) of the image displayed on the display means.

### Platform:

The apparatus of the invention comprises a platform, said platform having an upper surface said upper surface providing a recess that receives at least a portion of a PID such that when the PID is placed in the recess: (a) the PID is substantially restrained from transverse movement; (b) permits operation of the controls of the imaging system and/or illumination source of the PID; and (c) permits visualization of the display by the user, the platform further providing an aperture such that when said PID is placed in the recess of the platform the camera is capable of imaging objects beneath the platform through the aperture.

The recess in the upper surface of the platform is configured to closely receive a PID so as to restrain the PID from transverse movement when associated with the platform yet permit access to the PID controls and visualization of the display. As used herein, the term “closely receive” is used to describe the difference in dimensions between the inner surface of the recess and the external surface of the PID to be received into the recess of the platform or PID-adapter. A PID is closely received when there exists a gap between the external surfaces of the PID and the internal surface of the recess of less than or equal to 10 mm, less than or equal to 8 mm, less than or equal to 6 mm, less than or equal to 5 mm, less than or equal to 4 mm, less than or equal to 3 mm, less than or equal to 2 mm, less than or equal to 1 mm, or less than or equal to 0.5 mm. In one embodiment, the recess closely receives a PID when the inner dimensions of the recess are approximately equal to the outer dimensions of the PID to be received with essentially no gap between the PID and the inner surface of the recess. When the PID is closely received in the recess it is restrained from movement. Design of the PID receiving recess to closely receive the PID may be readily accomplished by those of skill in the art by reference to the external dimension of the PID. The external dimensions of PID devices are readily determined from examination of the device or from developer resources provided by the manufacturer. For example, technical specifications for Apple brand PIDs are provided in a document entitled “Case Design Guidelines for Apple Devices Release R8” Oct. 16, 2014, Apple, Inc. Cupertino Calif. available at: https://developer.apple.com/resources/cases/Case-Design-Guidelines.pdf. Similar resources are available for Samsung PID devices at http://developer.samsung.com/resources.

In another embodiment of the invention, rather than the platform being designed specifically to receive a particular PID, the upper surface of the platform is configured to receive a PID adapter that may be reversibly associated with the surface of the platform.

Restraint of transverse movement may be augmented by one or more means known to those of skill in the art such as providing a recess to receive the PID adapter, through the use of locating pins and corresponding recesses or apertures in the PID or surface (or vice versa), through the use of magnets positioned appropriately in the surface of the platform and/or PID adapter (or vice versa), and the like. In this manner, a single platform and support means can be used with multiple PID devices through the use of different PID adapters.

The shape of the platform is not limited to any particular configuration. However, the platform is generally provided in a substantially rectangular configuration to correspond to the shape of most printed materials (e.g., US letter, US legal, A3, A4, A5, B5) as well as accommodating the conventional rectangular shape of most PIDs (e.g. iPhones, iPads, Galaxy S series smartphones, Galaxy Tabs).

### Aperture:

To enable transmission of light to the object positioned below the platform to be imaged to the image capture system of the PID when said PID is associated with the platform, the platform provides an aperture for the passage of light. Such aperture may be a simple opening in the platform (or PID adapter if so configured) or be provided with a substantially transparent material to allow the passage of light from the object to be imaged to the image sensor of the PID. If a material is provided in the aperture, such material should not inhibit the operation of the functions of the image capture system of the PID, such as autofocus controls, exposure controls, and light meters. In one embodiment of the invention, the aperture is designed to not only enable the passage of light from the object to the imaging system but also the passage of light from the illumination source of the PID, if so equipped, to enable the imaging of objects using the internal illumination source of the PID. In one embodiment, the aperture is provided in the approximate center of the platform so as to maximize the area under the platform available for imaging.

One or more optical devices that alter the path or concentration of light reflected from the surface of the object to be imaged by the camera may be associated with the aperture. Such optical devices may be provided to enhance the quality of the image by employing one or more of a variety of known optical concentrators and/or lenses. Examples of lenses which may be employed include one or more of the collimating lenses, spherical lenses, symmetrical (e.g. biconcave), asymmetrical concave (e.g. planoconcave) or negative meniscus lenses and combinations thereof may be employed to bend, intensify, constrain, and improve the image quality which is transferred to the image sensor of the PID device. In one embodiment of the invention, a negative (diverging) lens is incorporated into the apparatus and positioned under the aperture provided for the image sensor. The use of such lenses facilitates the placement of the platform of the apparatus (and consequently the PID image capture system) closer to the object to be imaged enabling the use of more compact supports. It will be appreciated by the skilled artisan that various models of PIDs have different lenses and focal lengths of their integrated image capture systems. Consequently, when the apparatus is being designed for a specific model of PID (or the interchangeable adapter is designed for a specific PID) one or more lenses may be provided that optimize the capture of the image for the specific PID being used. The lenses may be permanently associated with aperture of the platform (or PID adapter) or be removable/interchangeable.

The camera of a PID is typically incorporates a wide-angle lens. Wide-angle lenses can result in distorted images resulting in a non-natural appearance of the subject. The apparatus of the present invention may optionally include one or more lenses to correct optical distortions such as barrel distortion. Correction of wide-angle lens distortion may be accomplished by the apparatus of the present invention positioning a lens between the object to be imaged by the camera and the camera. In one embodiment, said image correcting lens is incorporated into the platform such that when the PID is stably associated with the platform, the lens is positioned over the aperture. Correction of wide-angle lens distortion may also be accomplished by software, resident on or in communication with the PID.

### Supports:

The platform is maintained in a substantially horizontal elevated position above a surface through the use of one, two, three, four or more supports. The supports may be conventional supports which are retractable by means of being rotatably, pivotally or hingedly attached to the platform to enable them to be moved by an operator from a first retracted position to a second extended position (or vice versa) thereby providing the platform in an elevated position above and in a plane substantially parallel to the surface which is contacted by the supports. The supports communicate with the platform through the use of conventional linkages enabling rotatable, pivotal, or hinged linkages through the use of swivels, pivots, pins, and/or hinges (including active hinged mechanisms). It is desirable to maintain the platform in a stable position above the object to be imaged. Consequently means to restrain the movement of the platform relative to the support may be employed at the support/platform interface. Such means are readily apparent to one of skill in the art and include but are not limited to frictional interfaces, detents, grooved interpolating surfaces and the like. The platform may also provide means to retain the movable supports in a contracted position through the use of conventional clamps, spring clips, magnetic contacts, friction, detents, pins, and the like. Supports may be of any general cross-section (e.g., circular, square, rectangular, triangular, octagonal, etc.) in design and may be solid, hollow, or open such as through the employment of three sided U-shaped channel, or two-sided angled materials. The supports may also be telescoping to facilitate vertical positioning of the platform above the object to be imaged. It should be noted that when using a single support means to provide support for the platform, the base should be configured to have significant mass relative to the support, PID and platform to provide stability.

### Illumination Source:

Imaging of objects may be facilitated through illumination of the object by ambient lighting, an illumination source integral to the PID or an illumination source associated with the platform (100) of the apparatus of the present invention or a combination of one or more the of the foregoing illumination sources. Some PID devices incorporate integral illumination sources which may be sufficient to illuminate the object to enable imaging. Examples of PID devices comprising integrated illumination sources are known in the art. Examples of such PID devices with integrated illumination systems useful in the practice of the present invention include but are not limited to the iPhone 4®, iPhone 4S®, iPhone 5® series (5S and 5C), iPod Touch® 5^{th} Generation, Samsung Galaxy SIII®, Samsung Galaxy Ace®, Galaxy, Nokia Lumia® 820, Nokia Lumia® 920, Nokia PureView 808®, Sony Xperia S®, Nokia N8®, Google Nexus One®, HTC One X®, Levovo IdeaTab®, Acer Iconia Tab® 700, Samsung Galaxy Tab® 7.0, LG Slate®, HTC Evo® 4G (2 LED light sources), HTC 10, Samsung Galaxy Tab® 10, Toshiba Thrive®, and Panasonic ToughPad® JT-B1.

In an alternative embodiment, particularly when employing PID devices which do not provide an integrated illumination source (e.g., iPhone® 3, iPad® Mini 1^{st} Generation) or where the integrated illumination source may be insufficient or inappropriate for the particular application or ambient lighting is insufficient to enable imaging of desired quality, the platform further provides one or more illumination sources associated with the underside of the platform to provide illumination of objects positioned under the platform. The term “illumination source” as used herein refers a device that converts electricity into electromagnetic radiation. Examples of illumination sources suitable for use in the practice of the present invention which provide illumination in the visible spectrum include but are not limited to one or more incandescent, fluorescent or LED lamps including combinations of one or more of said illumination sources. Illumination sources useful in the practice of the present invention are commercially available from a wide variety of suppliers and conformational adaption of the platform to accommodate such various illumination sources is readily apparent to the skilled artisan. The illumination source is in electrical communication with the power supply through one or more conductors.

In one embodiment, the illumination source is comprised of one or more light emitting diodes (LEDs). As compared to conventional incandescent or fluorescent illumination sources, LED illumination sources provide an advantage of low power consumption that may be advantageous in situations where the power supply for the apparatus is a portable power supply such as a battery. LEDs also provide light of high intensity and have a long service life. In one embodiment where LEDs are employed, the LEDs are dimmable LEDs providing for variable light output. LED illumination sources may provide illumination of various colors including but not limited to white, red, blue, infrared and ultraviolet for the imaging of specific items such as the imaging of electrophoresis (e.g. thin layer, agarose, polyacrylamide) gels or immunoassays (e.g. lateral flow immunoassay devices or ELISA plates) using compounds that fluoresce under certain circumstance. LED light sources provide advantages such as high light intensity, low power consumption and long life. In one embodiment of the invention, one or more illumination sources is incorporated into the underside of the platform to provide illumination of the object to facilitate imaging. LED illumination sources are commercially available from a wide variety of suppliers that emit electromagnetic radiation in the infrared, visible and ultraviolet ranges suitable for use in the present invention.

LED illumination sources are available in a variety of color temperatures, output, operating voltages and physical configurations including elongated tube lights and strip lights, particularly strip lights having red, green and blue LEDs (RGB LED strip lights). Variable output LED strip lighting is commercially available from a variety of suppliers including OSRAM Sylvania, Philips, and General Electric. One example of a commercially available LED tube light is the Seesmart Model No. 200621 tube light comprising 30 LEDs providing an output of approximately 204 lumens at a color temperature of 4000K-4500K (commercially available from Seesmart, Inc., 4139 Guardian Street, Simi Valley Calif. 93063). Fixed and variable color LED lighting systems are available from Philips Color Kinetics (3 Burlington Woods Drive, Burlington Mass. 01801) marketed under the Color Kinetics®, including but not limited to the ColorGraze, Essential Color (eColor), Vaya Cove Color, Vaya Linear, Vaya Linear Color, Vaya Linear MP, Vaya Linear MP RGB.

The supports may also provide adjustability to the height of the platform by being extendible. In one embodiment of the invention, the supports provide a fixed element operably attached to the platform and one or more extendable elements associated with the fixed element (generally provided in a telescoping fashion) that enable adjustability to the length of the support. The position of the telescoping element(s) may be infinitely variable or adjustable to set positions using conventional spring-loaded detent mechanisms, clamps, compressive collars, and the like. Such extendible supports may provide markings on the extendable portion to assist the operator and correspond to the optical properties (e.g. focal length) of the imaging system of particular PIDs (such as “iPhone5”) for appropriate elevation of a particular PID above a surface on which the object is placed for optimal imaging of the particular object based on the particular imaging characteristics of the PID imaging system. When a single support is used, the apparatus further comprises a base structure to anchor the lower end of the support. An illustrative embodiment of the use. The supports may be provided separate from the platform, the platform being designed to reversibly and stably receive the supports, such stable and reversible retention achieved through the use of threaded or close fitting cavities integrated into or associated with the underside of the platform.

In an alternative embodiment of the invention employing two supports the support members may be configured as substantially planar panels which are hingedly attached to the underside of the platform. In this embodiment of the invention, the supports are capable of providing protection to any components exposed on the underside of the platform (e.g. lighting system, electronics, wiring, and/or power source) when the supports are in the retracted position. This system also inhibits the entrance of ambient light from the viewing area of the PID which may be useful when illuminating an object with a particular form of light for optimal image recognition and interpretation. An example of this situation is the use of the present invention to image a lateral flow immunodiagnostic employing UV markers wherein the present invention is used to provide ultraviolet light to facilitate illumination of the UV markers on the immunodiagnostic device and, optionally the interpretation of the image by software of the PID system.

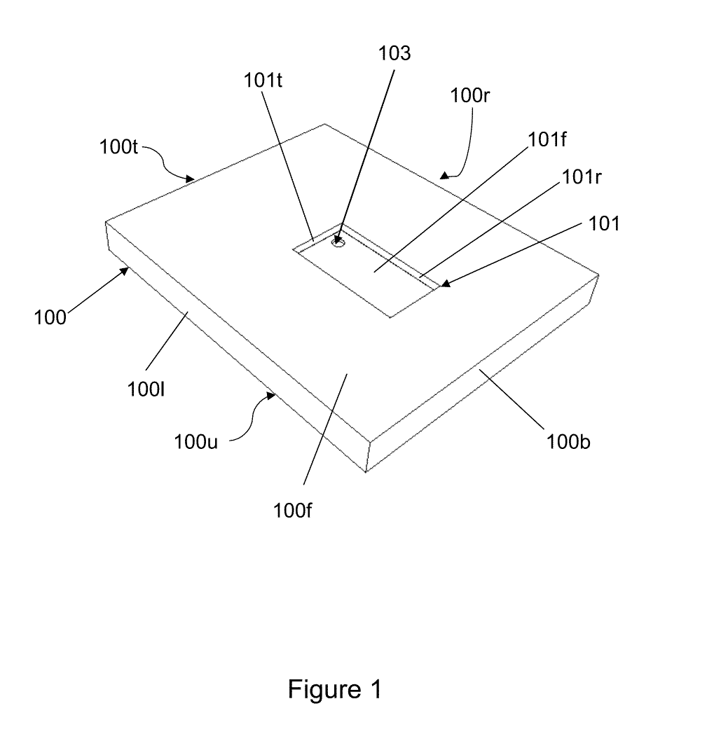

A variety of embodiments of the present invention are provided in the attached figures. FIG. 1 provides an upper perspective view of the platform (100), said platform having an front surface (100f) and a under surface (100u) joined by contiguous walls on the left (1001), right (100r), top (100t) and bottom (100b), the front surface (1000 providing a recess (101) to receive at least a portion of a PID said recess defined by a face (1010 and walls contiguous on the left (1011, not shown), top (101t), right (101r) and bottom (101b not shown), the face (1010 of the recess (101) providing an aperture (103) which pierces the body of the platform (100) enabling light to pass through the platform from underneath the platform.

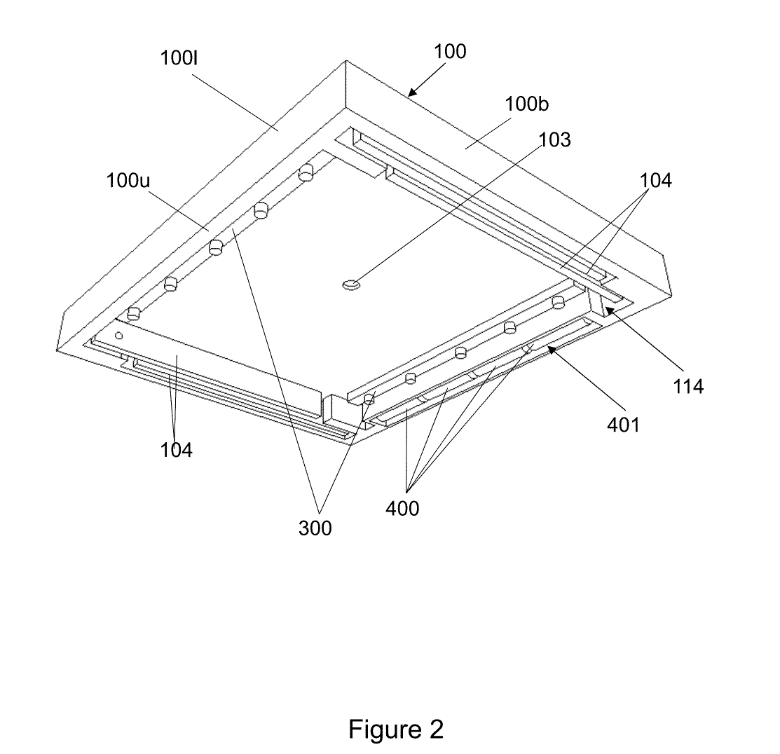

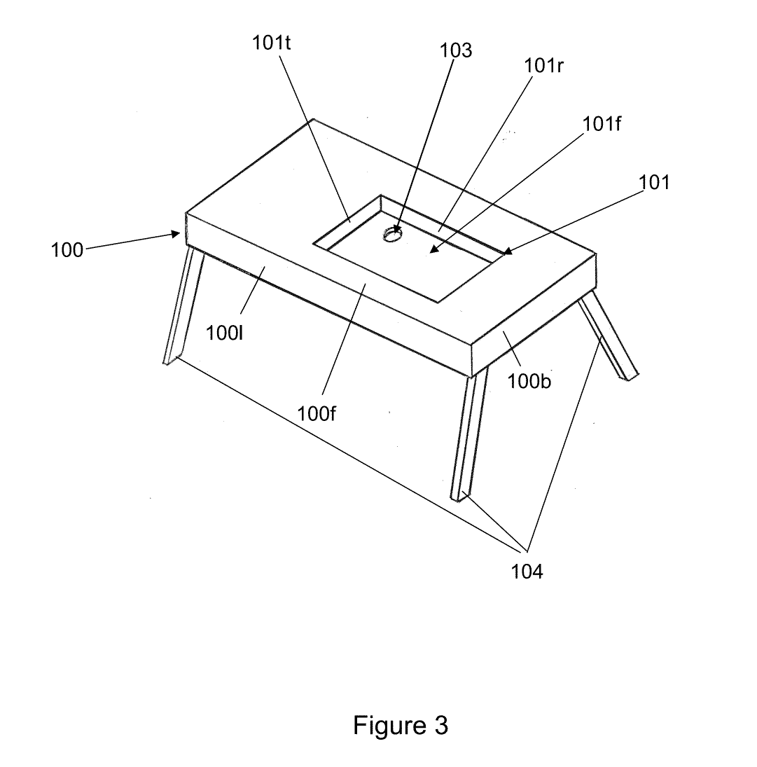

In one embodiment of the invention, four support members are employed to support the platform, exemplary embodiments of which are illustrated in FIGS. 2 and 3 of the attached drawings. FIG. 2 provides a lower perspective view of the under surface (100u) of the platform (100) illustrating: the 4 battery power supply (400) which is provided in a recess (401) in the under surface (100u) of the platform (100); the aperture (103) which pierces the body of the platform (100); illumination sources (300) which are in electrical communication with the power supply (400) through wires (not shown) in the body of the platform; and four supports (104) shown here in a retracted position in to recess (114) provided in the under surface (100u) of the platform (100).

FIG. 3 provides an upper perspective view of the platform (100) similar to that illustrated in FIG. 2 illustrating the platform (100), said platform having an front surface (1000 and a under surface (100u, not shown) joined by contiguous walls on the left (1001), (100t, not shown), right (100r, not shown) and bottom (100b), the front surface (1000 providing a recess (101) to receive at least a portion of a PID said recess defined by a face (101f) and walls contiguous on the left (1011, not shown), top (101t), right (101r) and bottom (101b not shown), the face (101f) of the recess (101) providing an aperture (103) which pierces the body of the platform (100), the supports (104) being shown in their extended position.

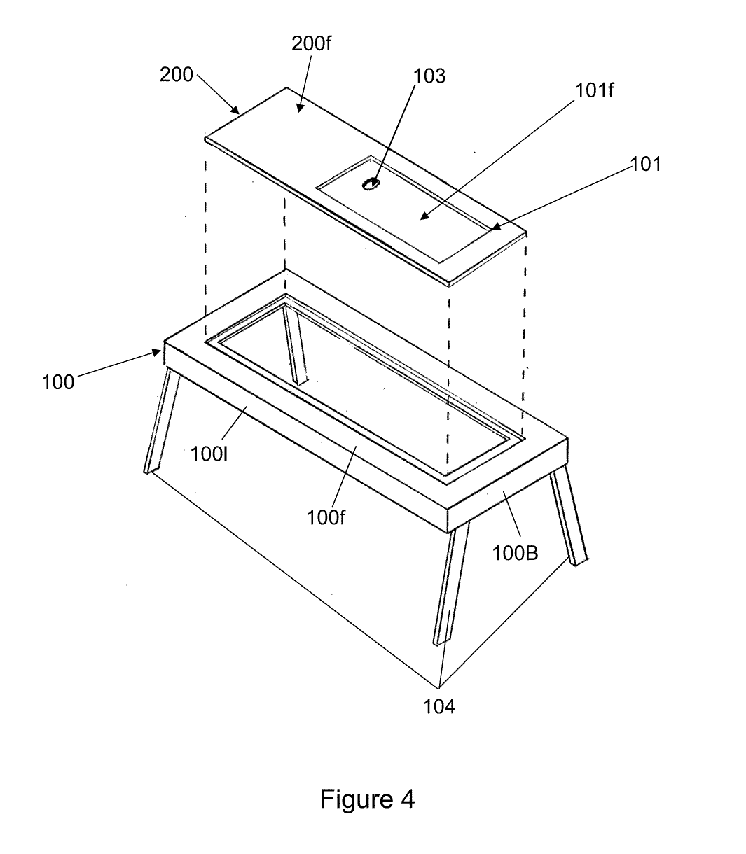

FIG. 4 of the attached drawings provides an upper perspective exploded view of one embodiment of the apparatus of the present invention illustrating the configuration of platform (100) when used in association with a PID adapter (200). As illustrated, the upper surface (100f) of the platform (100) is configured to receive a PID adapter (200) which is inserted into the platform (100) as indicated by the dotted lines, the PID adapter (200) providing on its upper surface (200f) the recess (101) for receiving a PID, an aperture (103) which pierce the body of the PID adapter (200) and four supports (104) shown in an extended position.

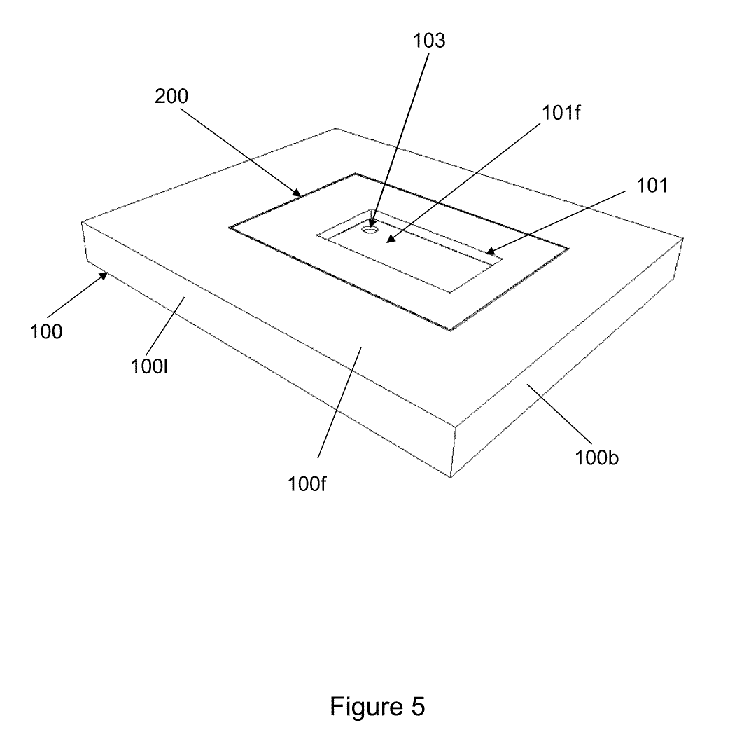

FIG. 5 of the attached drawings provides an upper perspective assembled view of one embodiment of the platform (100) left wall (1001) bottom wall (100b) and illustrating the PID adapter (200), said PID adapter (200) providing a recess (101) to receive a PID (not shown), the face (100f) of the recess (101) providing an aperture (103) piercing the body of the PID adapter (200) in association with front surface (100f) of the platform (100).

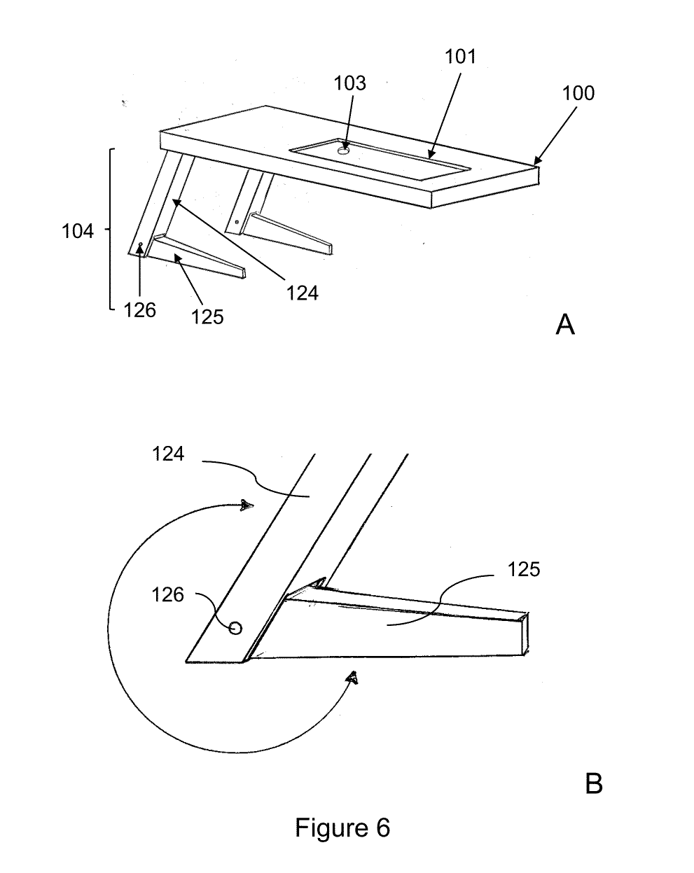

FIG. 6 of the attached drawings provides an illustrative embodiment of the invention using two supports. Fewer supports simplify the design and facilitate the insertion of objects beneath the platform. As illustrated in FIG. 6, Panel A, the platform (100) providing the aperture (103) and recess (101) is supported by two supports (104) each of which comprises an upper member (124) and a lower member (125) which rotate about a pivot pin (126), the upper member being hingedly attached to the under surface of the platform (not shown). In typical use, the lower portion (125) of the support (104) rotates into a receiving pocket (not shown) on the reverse side of the upper portion (125), the upper portion (124) then rotates up into a recess (not shown) in the under surface of the platform (100). This configuration enables the supports to retracted into recesses in the under surface of the body of the platform enabling easy storage. This rotational relationship illustrated in FIG. 6, Panel B, the upper portion (124) of the two-piece support (104) rotates from a first retracted position to a second position through an angle generally greater than 90 degrees, its further rotation inhibited by detents or interference with the structure of the platform (100). As indicted by the curved arrow, the lower member (125) of the support (104) rotates from a first position a recess provide in the reverse side (not shown) of the upper member (124) to a second position through an angle greater than 90 degrees, its further rotation retarded being inhibited by detents or interference with the structure of the upper member. When the supports (104) are in their fully extended configuration, the lower members (125) of each support (104) are substantially parallel to the surface of the platform (100) such that the platform (100) is maintained in a plane substantially parallel to the surface on which the apparatus is placed. Although illustrated using a pivot pin (126), it will be appreciated by those of skill in the art that the means for facilitating rotational movement of the upper and lower members of such an articulated two-piece support may be of many conventional forms for enabling rotational movement such as hinges, pins, rivets, formed-in pivot points, and the like.

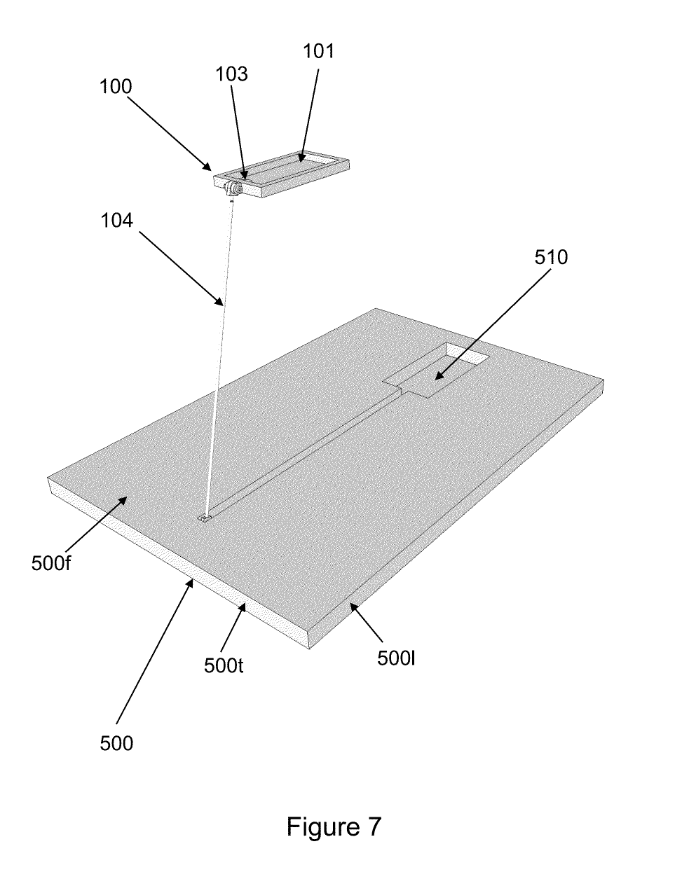

FIG. 7 of the attached drawings provides an upper perspective view of one embodiment of the invention where the platform (100) comprising the recess (101) and aperture (103) s supported by a single support (104) which is hingedly attached at its lower extent to a base structure (500) defined by a front wall (500f) and under wall (500u) and four continuous side walls on the left (5001), top (500t), right and bottom (not shown), the front wall (5000 of the base (500) and hingedly attached at its upper extent to the platform (100). Although the support (104) is shown here in its extended configuration elevating the platform (100), as illustrated, the front face (5000 of the base (500) provides a recess (510) to receive the support (104) and platform (100) when the support (104) and platform (100) are retracted. In this embodiment, the support (104) is of telescoping design enabling placement of the PID at any of a variety of positions above the object to be imaged. As appreciated by one of skill in the art, the hinged joints provided between each end of the support (104), the platform (100) and base (500) provide significant resistance to rotation, said resistance being fixed or variable through the use of compressive fasteners or the like.

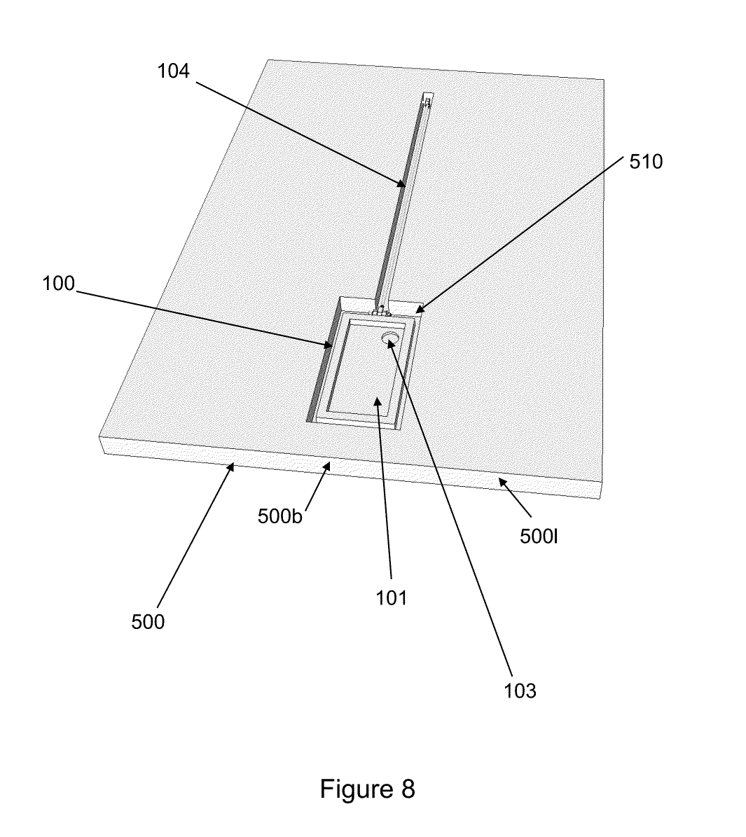

FIG. 8 provides an upper perspective view of one embodiment of the invention substantially similar to that provided in FIG. 7 wherein the platform (100) is supported by a single support (104) and base (500), illustrated in this FIG. 8 in its retracted position, the support (104) and platform (100) being received by the recess (510) in the upper surface (500f) of the base (500), the support (104) being telescopic and hingedly attached to the platform at its upper extent and hingedly attached to the base at its lower extent.

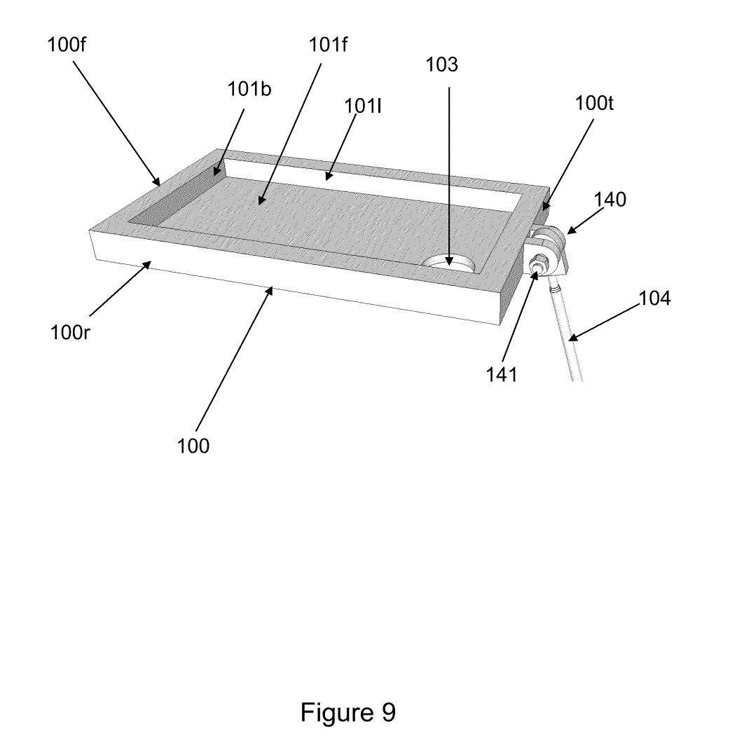

FIG. 9 provides a detail of one embodiment of the invention substantially similar to that provided in FIGS. 7 and 8, illustrating the hinge (140) between the support (104) and the platform (100), the rotational resistance of the hinge (140) being rendered variable through the use of a threaded fastener and adjusting nut (141). This right side view of the platform shows the right wall (100r) and top wall (100t) of the platform, the platform face (100f), the recess (101) including the front face (100f), the left wall (1011) and bottom wall (101b) which define the recess in addition to the top and right walls (not shown) and also illustrating the aperture (103) which pierces the body of the platform (100).

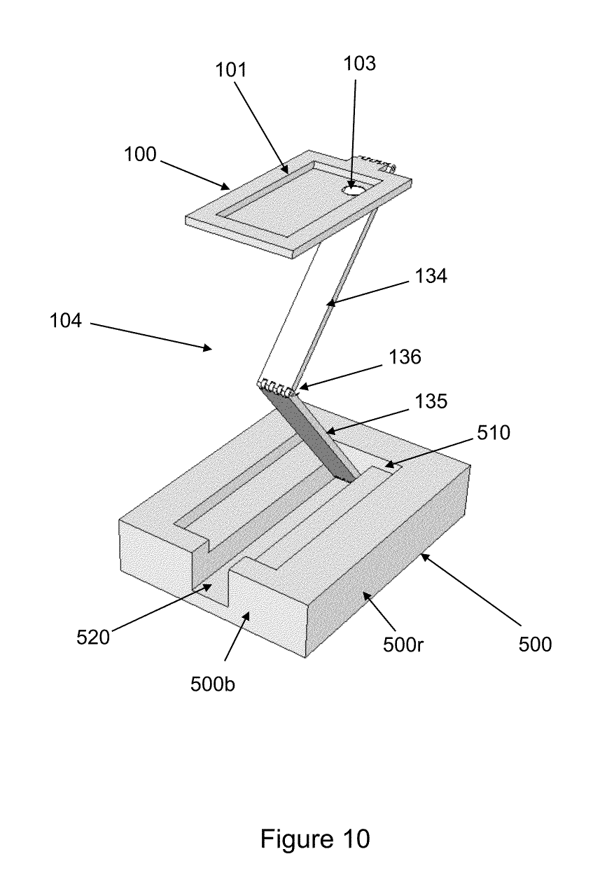

An alternative single support configuration is provided in FIG. 10. In contrast to a telescoping support, this configuration uses a folding articulated support which provides rotational resistance to the platform as well as support. As illustrated in its extended configuration, the platform (100) comprising the recess (101) and aperture (103) is supported by a single articulated two-piece support (104) having an upper portion (134) and a lower portion (135) attached through a hinged (136), said support (104) also being hingedly attached to the platform at its upper extent and hingedly attached to the base at its lower extent (not shown). Also illustrated in FIG. 10 are recesses provided in the base (500), a support-receiving recess (520) and platform receiving recess (510).

### Diagnostic Applications:

As previously noted, the present apparatus may be employed to image a wide variety of materials. In one embodiment of the invention, the apparatus may be employed to image body parts (such as a hand of human subject). The image data provided may further be analyzed by image analysis software to identify potential disease states. The use of ultraviolet and/or infrared illumination sources may facilitate such diagnostic applications of the device to identify certain disease states which may be enhanced under such illumination conditions.

The present invention further facilitates the interpretation of electrophoresis gels. The imaging systems of conventionally available PIDs enables high-resolution analysis of objects which may then be further analyzed by software applications for interpretation. For example, the conventional enzyme linked immunoassay procedures used in diagnostic devices such as lateral flow immunoassay devices (e.g. home pregnancy tests) often provide a colored element facilitating interpretation of the test by the operator. In many instances, the coloration provided can be faint or of little discernable difference to the naked eye. The present invention facilitates the use of the imaging system of the PID in cooperation with software, either installed on the PID or a computer system in operable communication with the PID through a computer network, device, to interpret the results of such diagnostic devices. Additionally, since the present invention provides for illumination sources such as ultraviolet illumination, the present invention facilitates the imaging of such two dimensional objects wherein the markers used may be fluorescent markers which provide a significantly stronger signal when exposed to light of an appropriate wavelength enabling the visualization of test results that would not be visible to the human eye absent the use of such fluorescent marker compounds.

### Power Supply:

When said illumination source is incorporated into the apparatus, the power supply for the illumination source may be provided by electrical communication with an external power supply (electrical cord and/or power adapter) or the power supply may be incorporated into the apparatus using a portable power supply (e.g., one or more batteries, solar cell, etc). In one embodiment of the invention when supplying illumination, the apparatus comprises an integrated, self-contained power supply. Such a configuration facilitates the portability of the apparatus. Such self-contained power supply may comprise one or more batteries. In one embodiment, the platform is configured to reversibly retain one or more such batteries as a power supply and provides a means for electrical communication between the power supply and the illumination source. The battery may be non-rechargeable or rechargeable. Examples of batteries useful in the practice of the present invention include zinc-carbon, zinc-chloride, alkaline (e.g., zinc-manganese dioxide), lithium (e.g., lithium-copper oxide, lithium-iron disulfide, lithium manganese dioxide), silver oxide, silver-zinc, NiCd, NiMH, NiZn, lithium ion batteries. The term battery includes a single cell or a plurality of two or more cells. The apparatus may also incorporate or be provided with a solar collector for charging the battery source. For purposes of shipment and extended shelf life, there may be an operator-removable physical barrier introduced between the power source and the circuitry of the remainder of the transmission module to preserve the battery power source during storage and shipment and guard against parasitic drain of the battery(ies). When one or more rechargeable batteries are employed as the power source, the device of the present invention may also be provided with a external charging system appropriate for the particular configuration and specifications of the rechargeable battery employed and the platform providing a plug system for reversible association of the external charging system with the platform containing the rechargeable batteries.

### Electrical Components:

In embodiments where an illumination source is incorporated into the apparatus, the illumination source is operably connected to the power supply through one or more conductors and incorporates a switch. The illumination source may provide a fixed or variable level of illumination. In one embodiment of the invention, the switch is a single throw (on/off) switch incorporated into the apparatus. In one embodiment of the invention the switch is operably connected to one or more supports (104) such that when the support (104) member is extended the illumination source is automatically switched on. In one embodiment of the invention, the extent of illumination provided by the illumination source provides a variable level of illumination that is be manually controlled through the use of conventional variable electronic switches and circuits switched or variable by external means (e.g. a “dimmer” switch) to achieve a particular level of illumination. Such variable control of illumination levels provide advantages such as to avoid potential overloading of the capacity of the image sensor of the PID, particularly when such devices incorporate a CCD image sensor. In one embodiment of the invention the illumination level provided by the illumination source may be varied by the illumination source (or PID device) based on image recognition, light recognition meters and/or controlled by software incorporated into the apparatus or associated with the PID.

### Materials

The platform, PID adapter (if employed) and supports may be constructed of any of a variety of materials that provide a substantially rigid platform for the support and retention of the PID. Examples of materials suitable for use in construction of the platform and supports include metals, plastics, wood, compressed paper, glass, rigid foams, cardboard, and/or ceramics. The platform, PID adapter (if employed) and/or supports may be constructed from the same materials or may be produced from different materials. Examples of metals useful in the construction of the platform and/or supports include but are not limited to steel and steel alloys (e.g. stainless steel), aluminum and aluminum alloys, and magnesium and magnesium alloys. Metals may be formed using conventional techniques such as stamping, casting, machining, forging (including powder forging), hydroforming, thermoforming, compression molding, or the like.

Examples of plastic materials useful in the construction of the platform and/or supports are well known in the art and the techniques involved in the forming of the materials are apparent to the skilled artisan. The term plastics includes but are not limited to polycarbonate (PC), polyethylene (PE), high density polyethylene (HDPE), polyetherimide (PEI), polysulfone (PSO), polyethersulfone (PES), polyethylene terepthalate (PET), polypropylene, polystyrene, high impact polystyrene (HIPS), acrylanitrile butadiene styrene (ABS), polyvinylchloride (PVC), acetal, Nylons (e.g., Nylon 4-6, Nylone 6-6, Nylon 11, or Nylon 12), acrylic-styrene-acetonitrile (ASA), polyester liquid crystal polymer (LCP), stylene acrylonitrile (SAN), polyvinyldiene difluoride (PVDF), melamine, phenolics and the like.

The platform, PID adapter and/or supports may also be constructed of composite materials such as glass or carbon fiber reinforced plastics. Such composite materials may be formed using conventional contact molding technologies such as hand lay-up or spray lay-up technologies.

In general when selecting materials for construction of the apparatus of the present invention, it is generally preferred to employ materials that do not significantly impair the ability of communication functions (e.g. cellular, Bluetooth®, Near-field Communications (NFC) or WiFi® systems) of the PID. Examples of such materials that minimize interference with the communication functions of the PID include but are not limited to non-ferrous metals, plastics, paper, wood, and ceramics and composites thereof. The following materials should be avoided or minimized in the construction of the platform:
Metals (e.g. steel, aluminum, magnesium, titanium, etc.)
Plastics with any carbon content
Plastics with any glass content
Plastics with metallic plating
Metallic paints
Black paints with high carbon loading
White paints with high titanium dioxide loading
Metallic Physical Vapor Deposition (PVD) coatings

Typical procedures for forming the materials including compression molding, blow molding, casting, extrusion, pressure forming, and the like. The techniques for forming such plastic materials into the conformations of the present invention are well known to those of skill in the art (see e.g. Olmsted and Davis (2001) Practical Injection Molding, Marcel Dekker New York; Rosato and Rosato (1986) Injection Molding Handbook; Van Nostrand Reinhold Company, New York). The elements of the apparatus including the platform, PID adapter (if employed) and/or supports may also be produced by deposition forming or additive manufacturing (often referred to as “3D printing”) using conventional materials such as plastic, metallic or metallic precursors.

The platform, PID adapter (if employed) and/or supports may further incorporate structural features to improve the rigidity of the platform and/or facilitate the attachment of other components. Such structural features enable the use of less material and facilitate portability by minimizing the weight of the apparatus. Examples of such structural features include ribs or bosses.

### Finishing:

In some instances, it may be desirable to provide a finish to the materials to minimize corrosion from atmospheric or operator sources or to improve durability, handing characteristics or appearance. Optionally, the materials may be electroplated, painted, dip-coated, or flocked to enhance appearance and/or durability. Optionally, portions of the supports in contact the support surface may also coated or fitted with non-slip materials.

Communication with Remote Devices:

The PID device may be a cellular phone, a tablet computer or similar device capable of communication (either wired or wirelessly) with other local or remote devices such as external computers, monitors, television displays, other PID devices, and computer networks. Such communication may be wireless communication protocols such as Wi-Fi™ 802.11 a/b/g/n, Bluetooth®, or cellular data transfer protocols such as GSM®, 3G, 4G, LTE and similar protocols for the wireless transfer of data. A PID device may provide communication by multiple of such communication protocols. For example, the iPhone® series of devices possesses the ability to communicate via cellular connection protocols, WiFi protocols, and Bluetooth protocols. Consequently, the image data obtained by the PID device may be communicated to other networked devices via these integrated communication systems.

The apparatus of the present invention may be provided in association with wireless display adapters to facilitate display of images captured by the camera of the PID onto remote display devices. Remote display devices include computer monitors, television sets, or digital projectors. Examples of such devices include but are not limited to the Microsoft Wireless Display Adapter (Model No. CG4-00001, Microsoft Corporation, Redmond Wash.), the Actiontec ScreenBeam Wireless Display Adapter (Model No. SBWD100KIT01, Actiontec Electronics, Inc.760 N Mary Ave, Sunnyvale, Calif. 94085), and the NETGEAR Push2TV Wireless Display Adapter (Model No. PTV3000-100NAS, NETGEAR, 350 Plumeria Drive, San Jose Calif.).

Alternatively to wireless communication systems, the PID may communicate with an external devices (e.g., desktops, laptops, displays, or projectors via a conventional wired cable. The platform (or PID adapter if employed) may be configured to accommodate such wired connections with the PID device when associated with the apparatus.

### Software:

The apparatus of the present invention may be further provided together with software capable of execution on a PID (or an external computing device in wireless or wired communication with the PID) to facilitate the imaging, analysis, storage and/or transfer of images. For example, the initiation of the software application may place the PID device (and/or remote devices in communication with the PID) in condition for display of the image to be captured by the image capture system of the PID on the PID display or the display on a remote device. For example such software may place the PID device in photo or video mode, turn on the illumination source, and enable controls such as illumination level, zoom control, exposure, and/or focus control of the lens of the PID device, recording, and broadcast of the signal to remote devices such as other networked computers and portable computing and communication devices. Additionally, software subroutines to suppress conflicting signals (such as incoming telephone calls, text messages, e-mails and the like) can be incorporated into the code to preclude interruptions of the display of image sensor signal and the view to the operator.

The software may also provide analysis of the images captured through the system. One example of such image analysis software provides for optical character recognition (OCR) of text of documents or software that facilitates communication with existing OCR software resident on the PID and/or remote device. Examples of software which may be used in conjunction with the apparatus of the present invention include the Office Lens software (Microsoft Corp., Redmond, Wash.)

Another example of such image analysis software is employed with respect to an electrophoresis gel, the software may provide an analysis of the image and translate the image into data relating to the amino acid or nucleotide sequence of the sample. In another embodiment, the software could provide diagnostic analysis of the image captured. Software applications are known in the art that are capable of through image to diagnose of certain physiological conditions (e.g. skin surface diseases such as melanoma) and provide diagnostic information to the user. In another embodiment, the image analysis software is used to interpret the results of a lateral flow immunoassay diagnostic device, where the markers used in such diagnostic device are visible in white light or visible in response to ultraviolet or infrared illumination.

Each module can be implemented as a software program stored on computer readable media provided in the PID device or external computing device. Computer-readable media in which such formatted data and/or instructions may be embodied include, but are not limited to, a tangible memory (e.g., random access memory, read only memory, memory cards, hard drives, etc.) to be read by a central processing unit to implement the functions.

The application software is accessed from within or loaded into the PID device or external computing device in communication with the PID. As disclosed herein, embodiments and features of the invention may be implemented through computer-hardware, software and/or firmware. Although some of the disclosed implementations describe components such as software, systems and methods consistent with the innovations herein may be implemented with any combination of hardware, software and/or firmware.

### Kits:

The present invention further provides a kit of parts comprising the apparatus of the present invention of to facilitate imaging of objects using a PID and instructions for use, optionally providing one or more of the item selected from the group consisting of: (a) power supplies, (b) PID adapters, (c) lenses, (d) wireless display adapters, and (e) software. In one embodiment, the power supply of the kit is a battery. In another embodiment, the power supply of the kit is an AC adapter comprising a transformer. In another embodiment, the kit provides both battery and AC adapter power supplies. In another embodiment, the power supply is provided by a conventional solar charging system comprising one or more solar collectors in electrical communication with the illumination source and/or battery. Kits of the present invention may also provide one or more PID adapters. Kits of the present invention may also provide one or more lenses. Kits of the present invention also may provide wireless display adapter. The term software includes the inclusion of software instructions provided on computer readable media (compact disc (CD), SD, micro SD, USB cards or the like) or the provision of a “software access key” to enable downloading and/or activation of software from a remote computer system.

I claim:

1. An apparatus to facilitate imaging of objects by a portable imaging device (PID), said apparatus comprising:
(a) a platform, said platform having an upper and lower surface, said platform further providing a recess on its upper surface to reversible receive at least a portion of a PID, said PID having an image capture system comprising a rear-facing camera,
(b) said platform further providing an aperture extending from the face of said recess to through the lower surface of said platform, said aperture enabling the passage of light through the body of the platform to the rear facing camera of a PID, and
(c) one or more supports, said supports being operably associated with said platform to facilitate stable elevation of the platform above a surface.

2. The apparatus of claim 1 further comprising an illumination source in association with the lower surface of said platform, said illumination source being in electrical communication with a power supply.

3. The apparatus of claim 2, wherein the power supply is a battery provided in association with the platform.

4. The apparatus of claim 1 wherein the apparatus employs four supports in operable association with the platform.

5. The apparatus of claim 1 wherein the apparatus employs two supports in operable association with the platform.

6. The apparatus of claim 1 wherein the apparatus employs one support in operable association with the platform, said apparatus further comprising a base attached to the lower end of said support.

7. The apparatus of claim 6 wherein the support is extendible.

8. The apparatus of claim 7 wherein the extendible support is telescoping.

9. The apparatus of claim 2 further comprising a lens stably and reversibly associated with the lower surface of the platform and concentric with the position of the camera aperture.

10. The apparatus of claim 1 wherein the recess is configured to receive an iPhone.

11. The apparatus of claim 10 wherein the iPhone is an iPhone 6.

12. An apparatus to facilitate imaging of objects by a portable imaging device (PID), said apparatus comprising:
(a) a platform, said platform having an upper and lower surface, said platform further providing a recess on its upper surface to reversibly receive at least a portion of a PID adapter,
(b) A PID adapter having an upper and lower surface the upper surface of said PID adapter providing a recess to receive at least a portion of a PID, said PID having an image capture system comprising a rear-facing camera,
(c) said PID adapter further providing an aperture extending from the face of said recess to through the lower surface of said PID adapter, said aperture enabling the passage of light through the body of the PID adapter to the rear facing camera of a PID, and
(d) one or more supports, said supports being operably associated with said platform to facilitate stable elevation of the platform above a surface.

13. The apparatus of claim 12 further comprising an illumination source in electrical communication with a power supply.

14. The apparatus of claim 12, wherein the power supply is integral to the apparatus.

15. The apparatus of claim 7 further comprising a lens stably and reversibly associated with the lower surface of the PID adapter and concentric with the position of the camera aperture.
